(19) United States
(12) Patent Application Publication
(10) Pub. No.: US 2024/0083170 A1
(43) Pub. Date: Mar. 14, 2024

(54) LIQUID EJECTING APPARATUS AND MAINTENANCE METHOD FOR LIQUID EJECTING HEAD

(71) Applicant: SEIKO EPSON CORPORATION, Tokyo (JP)

(72) Inventors: Koki HIRATA, NAGANO-SHI (JP); Tomoyuki MIYAZAWA, MATSUMOTO-SHI (JP); Yukihiro HANAOKA, SHIOJIRI-SHI (JP); Shun KATSUIE, MATSUMOTO-SHI (JP)

(21) Appl. No.: 18/462,969

(22) Filed: Sep. 7, 2023

(30) Foreign Application Priority Data
Sep. 9, 2022 (JP) 2022-143534

(51) Int. Cl. B41J 2/165; B41J 2/175; B41J 29/17

(52) U.S. Cl. CPC B41J 2/16526; B41J 2/16535; B41J 2/175; B41J 29/17

(57) ABSTRACT

A liquid ejecting apparatus includes a liquid ejecting head having a first-nozzle-row, a first-tank storing a first-liquid, a first-supply-flow-path for supplying the first-liquid to the first-nozzle-row from the first-tank, a first on-off valve provided in an intermediate portion of the first-supply-flow-path and configured to open and close the first-supply-flow-path, and a first-pressurizing-mechanism configured to pressurize an inside of the first-tank. A pressure inside the first-tank is set to a predetermined positive pressure by driving the first-pressurizing-mechanism in a closed state of the first on-off valve. Thereafter, a discharge process of discharging the first-liquid from the first-nozzle-row is performed by bringing the first on-off valve into an open state. In the discharge process, the first on-off valve is switched from the open state to the closed state at a timing at which the first-liquid is being continuously discharged from the first-nozzle-row.

The present application is based on, and claims priority from JP Application Serial Number 2022-143534, filed Sep. 9, 2022, the disclosure of which is here by incorporated by reference herein in its entirely.

### BACKGROUND

### 1. Technical Field

The present disclosure relates to a liquid ejecting apparatus and a maintenance method for a liquid ejecting head.

### 2. Related Art

A liquid ejecting apparatus represented by an ink jet printer generally includes a liquid ejecting head having a plurality of nozzles that eject a liquid such as an ink. In this liquid ejecting apparatus, for example, as disclosed in JP-A-2006-231773, in a state where the liquid ejecting head is not internally filled with the liquid or when an abnormality occurs in the liquid ejecting head, a pressurizing mechanism may be driven to pressurize a supply flow path. In some cases, the liquid ejecting apparatus may perform a filling process or a cleaning process of supplying the liquid to the liquid ejecting head from a tank.

However, as disclosed in JP-A-2006-231773, when the filling process or the cleaning process is performed by pressurizing the supply flow path, there is a possibility that the liquid may be wasted.

### SUMMARY

According to an aspect of the present disclosure, in order to solve the above-described problem, there is provided a liquid ejecting apparatus including a liquid ejecting head having a first nozzle row that ejects a first liquid, a first tank that stores the first liquid to be supplied to the first nozzle row, a first supply flow path for supplying the first liquid to the first nozzle row from the first tank, a first on-off valve provided in an intermediate portion of the first supply flow path and configured to open and close the first supply flow path, and a first pressurizing mechanism configured to pressurize an inside of the first tank. In a closed state of the first on-off valve, the first pressurizing mechanism is driven to set a pressure inside the first tank to a predetermined positive pressure, and thereafter, the first on-off valve is brought into an open state to perform a discharge process of discharging the first liquid from the first nozzle row. In the discharge process, the first on-off valve is switched from the open state to the closed state at a timing at which the first liquid is being continuously discharged from the first nozzle row.

According to another aspect of the present disclosure, there is provided a maintenance method for a liquid ejecting head having a first nozzle row that ejects a first liquid. The maintenance method includes a pressurizing step of pressurizing an inside of a first tank that stores the first liquid to be supplied to the first nozzle row in a closed state of a first supply flow path for supplying the first liquid to the first nozzle row from the first tank, an opening step of discharging the first liquid from the first nozzle row by opening the first supply flow path after the pressurizing step, and a closing step of closing the first supply flow path at a timing at which the first liquid is being continuously discharged from the first nozzle row by the opening step.

### BRIEF DESCRIPTION OF THE DRAWINGS

FIG. 1 is a schematic view illustrating a configuration example of a liquid ejecting apparatus according to a first embodiment.

FIG. 2 is a cross-sectional view of a head chip of a liquid ejecting head.

FIG. 3 is a schematic view of a liquid supply mechanism of the first embodiment.

FIG. 4 is a flowchart of a maintenance method for the liquid ejecting head according to the first embodiment.

FIG. 5 is a timing chart of the maintenance method for the liquid ejecting head according to the first embodiment.

FIG. 6 is a schematic view of a liquid supply mechanism of a second embodiment.

FIG. 7 is a cross-sectional view illustrating an example of a pressure regulating valve.

### DESCRIPTION OF EMBODIMENTS

Hereinafter, preferred embodiments according to the present disclosure will be described with reference to the accompanying drawings. In the drawings, dimensions and scales of each portion are appropriately different from actual ones, and some portions are schematically illustrated to facilitate understanding. In addition, the scope of the present disclosure is not limited to the forms unless the present disclosure is particularly limited in the following description.

Hereinafter, for convenience of description, an X-axis, a Y-axis and a Z-axis which intersect each other are appropriately used. In addition, hereinafter, one direction along the X-axis is an X1-direction, and a direction opposite to the X1-direction is an X2-direction. Similarly, directions opposite to each other along the Y-axis are a Y1-direction and a Y2-direction. In addition, directions opposite to each other along the Z-axis are a Z1-direction and a Z2-direction.

Here, typically, the Z-axis is a vertical axis, and the Z2-direction corresponds to a downward direction in a vertical direction. However, the Z-axis may not be the vertical axis. In addition, the X-axis, the Y-axis, and the Z-axis are typically orthogonal to each other. However, without being limited thereto, for example, all of these may intersect each other at an angle within a range of 80° or larger and 100° or smaller.

### 1. First Embodiment

### 1-1. Schematic Configuration of Liquid Ejecting Apparatus

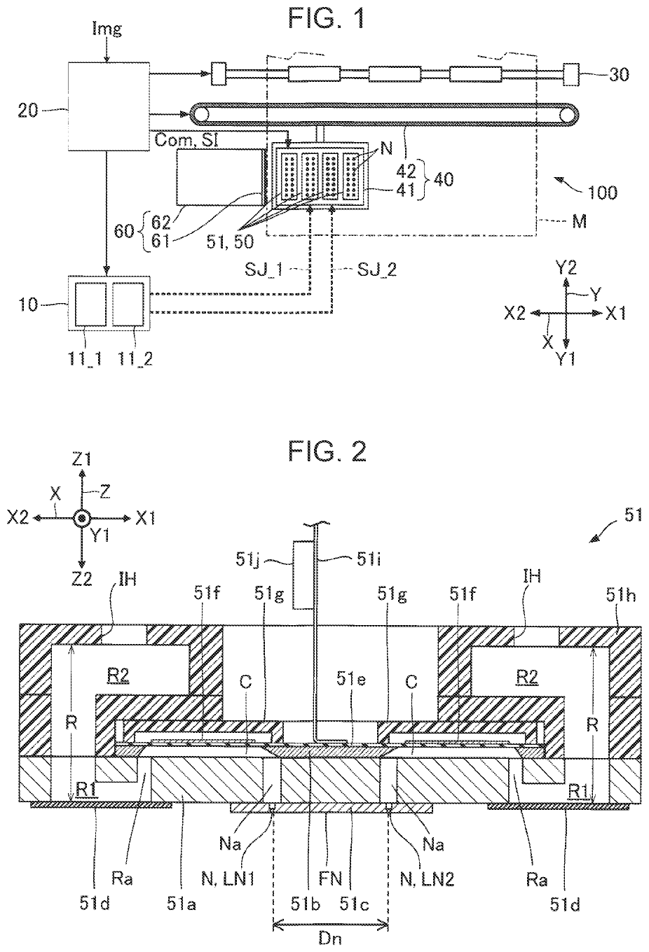

FIG. 1 is a schematic view illustrating a configuration example of a liquid ejecting apparatus 100 according to a first embodiment. The liquid ejecting apparatus 100 is an ink jet printing apparatus that ejects an ink, which is an example of a “liquid,” onto a medium M as a droplet. The medium M is typically a printing sheet. The medium M is not limited to the printing sheet, and may be a printing target having any desired material such as a resin film or a cloth.

As illustrated in FIG. 1, the liquid ejecting apparatus 100 includes a liquid supply mechanism 10, a control unit 20, a transport mechanism 30, a moving mechanism 40, a liquid ejecting head 50, and a maintenance mechanism 60. Hereinafter, all of these will be briefly described in order with reference to FIG. 1.

The liquid supply mechanism 10 supplies the ink to the liquid ejecting head 50. In an example illustrated in FIG. 1, the liquid supply mechanism 10 supplies a first liquid as the ink to the liquid ejecting head 50 via a first supply flow path SJ_1, and supplies a second liquid having a type different from a type of the first liquid as the ink to the liquid ejecting head 50 via a second supply flow path SJ_2. Each of the first supply flow path SJ_1 and the second supply flow path SJ_2 is formed of a flexible tube, for example.

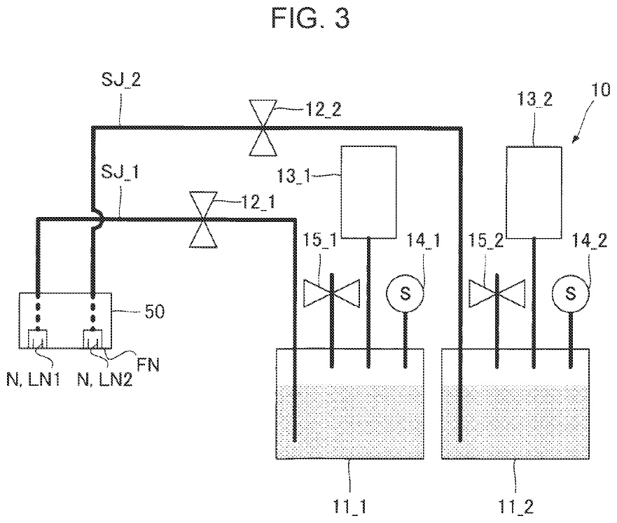

The liquid supply mechanism 10 includes a first tank 11_1 that stores the first liquid and a second tank 11_2 that stores the second liquid. For example, each specific aspect of the first tank 11_1 and the second tank 11_2 includes a cartridge that can be attached to and detached from the liquid ejecting apparatus 100, a bag-shaped ink pack formed of a flexible film, and an ink-replenishable ink tank. Details of the liquid supply mechanism 10 will be described later with reference to FIG. 3.

Each of the first tank 11_1 and the second tank 11_2 may be a sub tank that receives the ink supplied from a main tank. In this case, for example, it is preferable that an on-off valve is provided between the main tank and the sub tank to close the on-off valve during a discharge process (to be described later).

Each of the first liquid and the second liquid is not particularly limited, and for example, a water-based ink in which a coloring material such as a dye or a pigment is dissolved in a water-based solvent may be used, a solvent-based ink in which a coloring material is dissolved in an organic solvent may be used, or an ultraviolet curable ink may be used. alternatively, a clear ink, a white ink, or a process liquid may be used. The clear ink does not contain the coloring material, and is an ink for improving scratch resistance of a printed surface printed with the coloring material by overcoating the printed surface, or for reducing color deviations caused by irregular reflection by reducing unevenness caused by a pigment component. The white ink contains a white pigment, and is an ink for reducing non-whiteness caused by dirt on the medium M. The process liquid has reactivity with a component contained in a coloring material ink, and is an ink for improving fixability of the coloring material ink by coming into contact with the coloring material ink on the medium M. Hereinafter, each of the first liquid and the second liquid may be referred to as the ink in some cases.

For example, the control unit 20 includes a process circuit such as a Central Processing Unit (CPU) or a Field Programmable Gate Array (FPGA) and a storage circuit such as a semiconductor memory, and controls an operation of each element of the liquid ejecting apparatus 100.

The transport mechanism 30 transports the medium M in the Y1-direction under the control of the control unit 20. The moving mechanism 40 causes a plurality of the liquid ejecting heads 50 to reciprocate in the X1-direction and the X2-direction under the control of the control unit 20. In an example illustrated in FIG. 1, the moving mechanism 40 includes a substantially box-shaped transport body 41 called a carriage for accommodating the liquid ejecting head 50, and a transport belt 42 to which the transport body 41 is fixed. In addition to the plurality of liquid ejecting heads 50, a part of the liquid supply mechanism 10 may be mounted on the transport body 41.

Under the control of the control unit 20, the liquid ejecting head 50 ejects the ink supplied from the liquid supply mechanism 10 onto the medium M in the Z2-direction from each of a plurality of nozzles N. The ink is ejected concurrently when the medium M is transported by the transport mechanism 30 and the liquid ejecting head 50 is caused to reciprocate by the moving mechanism 40. In this manner, an image is formed on a surface of the medium M by using the ink.

Here, a drive signal Com for driving the liquid ejecting head 50 and a control signal SI for controlling driving of the liquid ejecting head 50 are supplied to the liquid ejecting head 50 from the control unit 20. The control signal SI is a signal for designating whether or not to supply the drive signal Com to a drive element 51f (to be described later) of the liquid ejecting head 50, and is generated, based on image data Img. The image data Img is information indicating an image, and is supplied to the control unit 20 from a host computer such as a personal computer or a digital camera.

In an example illustrated in FIG. 1, the liquid ejecting head 50 includes a plurality of head chips 51. Each of the plurality of head chips 51 is coupled to the liquid supply mechanism 10 via the first supply flow path SJ_1 and the second supply flow path SJ_2. Details of the head chip 51 will be described later with reference to FIG. 2. The number of the head chips 51 included in the liquid ejecting head 50 is not limited to the example illustrated in FIG. 1. The number may be selected in any desired way, and may be a single number.

The maintenance mechanism 60 is a mechanism for performing maintenance of the liquid ejecting head 50. In the example illustrated in FIG. 1, the maintenance mechanism 60 includes a wiping member 61 and a liquid receiving member 62.

The wiping member 61 is a member for wiping an ejecting surface FN of the liquid ejecting head 50. For example, the wiping member 61 is a blade-shaped elastic member made of rubber, or a fiber material such as a woven fabric or a non-woven fabric, or a porous member such as a sponge. From a viewpoint of suitably reducing contamination of the ink inside the nozzle N, it is preferable that the wiping member 61 is the porous member.

The wiping member 61 is disposed at a position deviated from a transport path of the medium M in a width direction (X2-direction) of the medium M. In a state where the wiping member 61 is in contact with the ejecting surface FN of the liquid ejecting head 50, the wiping member 61 is moved relative to the ejecting surface FN in a direction along the X-axis. In this manner, the wiping member 61 wipes off an adhering object of the ejecting surface FN. For example, the deviated position is one end point of the reciprocating movement of the liquid ejecting head 50, and is also referred to as a home position. A typical example of the adhering object is the ink or paper dust.

In the example illustrated in FIG. 1, the moving mechanism 40 moves the liquid ejecting head 50 in the direction along the X-axis. In this manner, the wiping member 61 moves relative to the ejecting surface FN in the direction along the X-axis. The wiping member 61 may be movable relative to the ejecting surface FN in the direction along the X-axis. For example, the wiping member 61 may be configured to be movable in the direction along the X-axis. In addition, the wiping member 61 may be configured to be movable in a direction along the Z-axis.

The liquid receiving member 62 receives the liquid ejected from the liquid ejecting head 50 located at the home position, as waste liquid. For example, the liquid receiving member 62 may be made of an absorbent body such as a fiber material or a sponge capable of absorbing the liquid, or may be a recessed container that opens toward the ejecting surface FN.

The maintenance mechanism 60 is not limited to the example illustrated in FIG. 1, and for example, may have a configuration other than the wiping member 61 and the liquid receiving member 62. For example, the maintenance mechanism 60 may have a cap mechanism that covers the ejecting surface FN.

### 1-2. Configuration of Head Chip

FIG. 2 is a cross-sectional view of the head chip 51 of the liquid ejecting head 50. As illustrated in FIG. 2, the head chip 51 includes the plurality of nozzles N arranged in a direction along the Y-axis. The plurality of nozzles N are divided into a first nozzle row LN1 and a second nozzle row LN2 which are aligned at a interval from each other in the direction along the X-axis. Each of the first nozzle row LN1 and the second nozzle row LN2 is a set of the plurality of nozzles N linearly arranged in the direction along the Y-axis. However, the first nozzle row LN1 ejects the first liquid, whereas the second nozzle row LN2 ejects the second liquid. Hereinafter, each of the first nozzle row LN1 and the second nozzle row LN2 may be referred to as a nozzle row LN in some cases.

The head chips 51 are configured to be substantially symmetrical to each other in the direction along the X-axis. However, positions of the plurality of nozzles N of the first nozzle row LN1 and the plurality of nozzles N of the second nozzle row LN2 in the direction along the Y-axis may coincide with or may be different from each other. As an example, FIG. 2 illustrates a configuration in which the positions of the plurality of nozzles N of the first nozzle row LN1 and the plurality of nozzles N of the second nozzle row LN2 coincide with each other in the direction along the Y-axis.

As illustrated in FIG. 2, the head chip 51 includes a flow path substrates 51a, a pressure chamber substrate 51b, a nozzle plate 51c, a vibration absorbing body 51d, a vibration plate 51e, a plurality of drive elements 51f, a protective plate 51g, a case 51h, and a wiring substrate 51i.

The flow path substrate 51a and the pressure chamber substrate 51b are stacked in this order in the Z1-direction, and form a flow path for supplying the ink to the plurality of nozzles N. The vibration plate 51e, the plurality of drive elements 51f, the protective plate 51g, the case 51h, and the wiring substrate 51i are installed in a region located in the Z1-direction with respect to a stack body formed by the flow path substrate 51a and the pressure chamber substrate 51b. On the other hand, the nozzle plate 51c and the vibration absorbing body 51d are installed in a region located in the Z2-direction with respect to the stack body. Each element of the head chip 51 is schematically a plate-shaped member elongated in the Y-direction, and the elements are joined to each other by using an adhesive, for example. Hereinafter, each element of the head chip 51 will be described in order.

The nozzle plate 51c is a plate-shaped member provided with the plurality of nozzles N of each of the first nozzle row LN1 and the second nozzle row LN2. Each of the plurality of nozzles N is a through-hole through which the ink passes. Here, a surface of the nozzle plate 51c facing the Z2-direction is the ejecting surface FN. The nozzle plate 51c is manufactured in such a manner that a silicon single crystal substrate is processed by a semiconductor manufacturing technique using a processing technique such as dry etching or wet etching, for example. However, other known methods and materials may be appropriately used for manufacturing the nozzle plate 51c. In addition, a cross-sectional shape of the nozzle is typically a circular shape, but the shape is not limited thereto, and may be a non-circular shape such as a polygon or an ellipse, for example.

A space R1, a plurality of individual flow paths Ra, and a plurality of communication flow paths Na are provided in the flow path substrate 51a for each of the first nozzle row LN1 and the second nozzle row LN2. The space R1 is an elongated opening extending in the direction along the Y-axis in a plan view in the direction along the Z-axis. Each of the individual flow path Ra and the communication flow path Na is a through-hole formed for every nozzle N. Each individual flow path Ra communicates with the space R1.

The pressure chamber substrate 51b is a plate-shaped member in which a plurality of pressure chambers C called cavities are formed for each of the first nozzle row LN1 and the second nozzle row LN2. The plurality of pressure chambers C are arranged in the direction along the Y-axis. Each of the pressure chambers C is an elongated space formed for every nozzle N and extending in the direction along the X-axis in a plan view. As in the above-described nozzle plate 51c, each of the flow path substrate 51a and the pressure chamber substrate 51b is manufactured in such a manner that a silicon single crystal substrate is processed by a semiconductor manufacturing technique, for example. However, other known methods and materials may be appropriately used for the manufacturing of each of the flow path substrate 51a and the pressure chamber substrate 51b.

The pressure chamber C is a space located between the flow path substrate 51a and the vibration plate 51e. The plurality of pressure chambers C are arranged in the direction along the Y-axis for each of the first nozzle row LN1 and the second nozzle row LN2. In addition, the pressure chamber C communicates with each of the communication flow path Na and the individual flow path Ra. Therefore, the pressure chamber C communicates with the nozzle N via the communication flow path Na, and communicates with the space R1 via the individual flow path Ra.

The vibration plate 51e is disposed on a surface of the pressure chamber substrate 51b facing the Z1-direction. The vibration plate 51e is a plate-shaped member which can elastically vibrate. For example, the vibration plate 51e includes an elastic film made of silicon oxide (SiO₂) and an insulating film made of zirconium oxide (ZrO₂), and these films are stacked in this order in the Z1-direction. For example, the elastic film is formed by thermally oxidizing one surface of a silicon single crystal substrate. For example, the insulating film is formed by forming a zirconium layer by sputtering and thermally oxidizing the layer. The vibration plate 51e is not limited to the above-described configuration in which the elastic film and the insulating film are stacked. For example, the configuration may include a single layer, or may include three or more layers.

The plurality of drive elements 51f mutually corresponding to the nozzles N are disposed on a surface of the vibration plate 51e facing the Z1-direction for each of the first nozzle row LN1 and the second nozzle row LN2. Each of the drive elements 51f is a passive element deformed by the supply of the drive signal. Each of the drive elements 51f has an elongated shape extending in the direction along the X-axis in a plan view. The plurality of drive elements 51f are arranged in the direction along the Y-axis to correspond to the plurality of pressure chambers C. The drive element 51f overlaps the pressure chamber C in a plan view.

Each of the drive elements 51f is a piezoelectric element, and although not illustrated, the drive element 51f includes a first electrode, a piezoelectric layer, and a second electrode, which are stacked in this order in the Z1-direction. One electrode of the first electrode and the second electrode is an individual electrode disposed apart from each other for every drive element 51f, and the drive signal Com is supplied to the one electrode. The other electrode of the first electrode and the second electrode is a band-shaped common electrode extending in the direction along the Y-axis to be continuous over the plurality of drive elements 51f, and for example, a constant potential is supplied to the other electrode. For example, a metal material of the electrodes includes metal material such as platinum (Pt), aluminum (Al), nickel (Ni), gold (Au), and copper (Cu). Out of the materials, one type can be used alone, or two or more types can be used in combination in an alloyed or stacked manner. The piezoelectric layer is made of a piezoelectric material such as lead zirconate titanate (Pb(Zr, Ti)O₃), and for example, has a band shape extending in the direction along the Y-axis to be continuous over the plurality of drive elements 51f. However, the piezoelectric layer may be integrated over the plurality of drive elements 51f In this case, the piezoelectric layer is provided with a through-hole penetrating the piezoelectric layer to extend in the direction along the X-axis in a region corresponding to a gap between the pressure chambers C adjacent to each other in a plan view. When the vibration plate 51e vibrates in conjunction with deformation of the above-described drive elements 51f, the pressure inside the pressure chambers C fluctuates to eject the ink from the nozzle N.

The protective plate 51g is a plate-shaped member installed on a surface of the vibration plate 51e facing the Z1-direction, protects the plurality of drive elements 51f, and reinforces mechanical strength of the vibration plate 51e. Here, the plurality of drive elements 51f are accommodated between the protective plate 51g and the vibration plate 51e. For example, the protective plate 51g is made of a resin material.

The case 51h is a member for storing the ink to be supplied to the plurality of pressure chambers C. For example, the case 51h is made of a resin material. The case 51h is provided with a space R2 for each of the first nozzle row LN1 and the second nozzle row LN2. The space R2 is a space communicating with the above-described space R1, and functions as a reservoir R that stores the ink to be supplied to the plurality of pressure chambers C together with the space R1. The case 51h is provided with an introduction port IH for supplying the ink to each reservoir R. The ink inside each reservoir R is supplied to the pressure chamber C via each individual flow path Ra.

Here, the introduction port IH corresponding to the first nozzle row LN1 communicates with the first supply flow path SJ_1. Therefore, the first liquid is supplied as the ink to the first nozzle row LN1. On the other hand, the introduction port IH corresponding to the second nozzle row LN2 communicates with the second supply flow path SJ_2. Therefore, the second liquid is supplied as the ink to the second nozzle row LN2. A portion of each of the first supply flow path SJ_1 and the second supply flow path SJ_2 may include a portion of the liquid ejecting head 50. Specifically, each of the first supply flow path SJ_1 and the second supply flow path SJ_2 may include the introduction port IH and the reservoir R of the liquid ejecting head 50. That is, the first supply flow path SJ_1 may be configured as a flow path from the first tank 11_1 to the plurality of individual flow paths Ra. Similarly, the second supply flow path SJ_2 may be configured as a flow path from the second tank 11_2 to the plurality of individual flow paths Ra.

The vibration absorbing body 51d is also referred to as a compliance substrate, is a flexible resin film forming a wall surface of the reservoir R, and absorbs pressure fluctuations of the ink inside the reservoir R. The vibration absorbing body 51d may be a flexible thin plate made of metal. A surface of the vibration absorbing body 51d facing the Z1-direction is joined to the flow path substrate 51a by using an adhesive.

The wiring substrate 51i is mounted on a surface of the vibration plate 51e facing the Z1-direction, and is a mounting component for electrically coupling the head chip 51, the drive circuit 51j, and the control unit 20. For example, the wiring substrate 51i is a flexible wiring substrate such as a chip on film (COF), a flexible printed circuit (FPC) or a flexible flat cable (FFC). The drive circuit 51j is mounted on the wiring substrate 51i of the present embodiment. The drive circuit 51j is a circuit including a switching element for switching whether or not to supply at least a portion of a waveform included in the drive signal Com to the drive element 51f as a drive pulse, based on the control signal SI.

In the above-described head chip 51, since the drive element 51f is driven by the drive signal Com, the pressure inside the pressure chamber C fluctuates, and the ink is ejected from the nozzle N in accordance with the fluctuation. Here, whereas the first liquid is ejected from the first nozzle row LN1, the second liquid having a type different from a type of the first liquid is ejected from the second nozzle row LN2.

Here, a shortest distance Dn between the nozzles of the first nozzle row LN1 and the second nozzle row LN2 is not particularly limited, but is 1.5 mm or shorter, for example. The shortest distance Dn between the nozzles of the first nozzle row LN1 and the second nozzle row LN2 is a distance between the first nozzle row LN1 and the second nozzle row LN2 in an alignment direction (X direction in the present embodiment) of the first nozzle row LN1 and the second nozzle row LN2.

### 1-3. Configuration of Liquid Supply Mechanism

FIG. 3 is a schematic view of the liquid supply mechanism 10 of the first embodiment. In FIG. 3, out of components of the liquid supply mechanism 10, components corresponding to any one set of the first nozzle row LN1 and the second nozzle row LN2 are schematically illustrated. Components corresponding to the other set of the first nozzle row LN1 and the second nozzle row LN2 are configured in the same manner as the components corresponding to the any one set of the first nozzle row LN1 and the second nozzle row LN2. The components may be simultaneously controlled to operate, or may be independently controlled to operate.

As illustrated in FIG. 3, in addition to the above-described first tank 11_1 and second tank 11_2, the liquid supply mechanism 10 includes a first on-off valve 12_1, a second on-off valve 12_2, a first pressurizing mechanism 13_1, and a second pressurizing mechanism 13_2, a first pressure sensor 14_1, a second pressure sensor 14_2, a first atmospheric opening valve 15_1, and a second atmospheric opening valve 15_2.

The first on-off valve 12_1 is a valve mechanism provided in an intermediate portion of the first supply flow path SJ_1 and capable of opening and closing the first supply flow path SJ_1 under the control of the control unit 20. On the other hand, the second on-off valve 12_2 is a valve mechanism provided in an intermediate portion of the second supply flow path SJ_2 and capable of opening and closing the second supply flow path SJ_2 under the control of the control unit 20. Each of the first on-off valve 12_1 and the second on-off valve 12_2 is an electromagnetic valve, a diaphragm valve, or a needle valve, for example.

Here, the first supply flow path SJ_1 is a flow path for supplying the first liquid from the first tank 11_1 to the first nozzle row LN1. Therefore, in an open state of the first on-off valve 12_1, the first supply flow path SJ_1 is in an open state, and the supply of the first liquid from the first tank 11_1 to the first nozzle row LN1 is allowed. On the other hand, in a closed state of the first on-off valve 12_1, the first supply flow path SJ_1 is in a closed state, and the supply of the first liquid from the first tank 11_1 to the first nozzle row LN1 is not allowed.

Similarly, the second supply flow path SJ_2 is a flow path for supplying the second liquid from the second tank 11_2 to the second nozzle row LN2. Therefore, in an open state of the second on-off valve 12_2, the second supply flow path SJ_2 is in an open state, and the supply of the second liquid from the second tank 11_2 to the second nozzle row LN2 is allowed. On the other hand, in a closed state of the second on-off valve 12_2, the second supply flow path SJ_2 is in a closed state, and the supply of the second liquid from the second tank 11_2 to the second nozzle row LN2 is not allowed.

The first pressurizing mechanism 13_1 is a mechanism capable of pressurizing the inside of the first tank 11_1 under the control of the control unit 20. On the other hand, the second pressurizing mechanism 13_2 is a mechanism capable of pressurizing the inside of the second tank 11_2 under the control of the control unit 20. For example, each of the first pressurizing mechanism 13_1 and the second pressurizing mechanism 13_2 is a syringe pump, a diaphragm pump, a tube pump, or a compressor, and generates a positive pressure higher than the atmospheric pressure. Each of the first pressurizing mechanism 13_1 and the second pressurizing mechanism 13_2 may have a regulator for regulating the pressure. In addition, one of the first pressurizing mechanism 13_1 and the second pressurizing mechanism 13_2 may also serve as the other. That is, one pressurizing mechanism that also serves as both the first pressurizing mechanism 13_1 and the second pressurizing mechanism 13_2 may be provided for the first tank 11_1 and the second tank 11_2 in common.

The first pressure sensor 14_1 measures the pressure inside the first tank 11_1. On the other hand, the second pressure sensor 14_2 measures the pressure inside the second tank 11_2. Each of the first pressure sensor 14_1 and the second pressure sensor 14_2 is not particularly limited, and for example, a known diaphragm type pressure sensor can be used.

Information indicating each measurement result of the first pressure sensor 14_1 and the second pressure sensor 14_2 is input to the control unit 20. For example, the control unit 20 controls an operation of the first pressurizing mechanism 13_1 so that the pressure inside the first tank 11_1 becomes a predetermined pressure, based on the measurement result of the first pressure sensor 14_1. Similarly, for example, the control unit 20 controls an operation of the second pressurizing mechanism 13_2 so that the pressure inside the second tank 11_2 becomes a predetermined pressure, based on the measurement result of the second pressure sensor 14_2.

The first atmospheric opening valve 15_1 is a valve mechanism capable of opening and closing the inside of the first tank 11_1 to be open to the atmosphere, under the control of the control unit 20, and opens and closes a portion between the inside of the first tank 11_1 and an external space. That is, the first atmospheric opening valve 15_1 is controlled by the control unit 20 to be switchable between an open state where the inside of the first tank 11_1 is open to the atmosphere and a closed state where the inside of the first tank 11_1 is not open to the atmosphere. On the other hand, the second atmospheric opening valve 15_2 is a valve mechanism capable of opening and closing the inside of the second tank 11_2 to be open to the atmosphere, under the control of the control unit 20, and opens and closes a portion between the inside of the second tank 11_2 and the external space. That is, the second atmospheric opening valve 15_2 is controlled by the control unit 20 to be switchable between an open state where the inside of the second tank 11_2 is open to the atmosphere and a closed state where the inside of the second tank 11_2 is not open to the atmosphere. Each of the first atmospheric opening valve 15_1 and the second atmospheric opening valve 15_2 may be any valve that can be controlled from a device such as the control unit 20, and is a diaphragm valve, an electromagnetic valve, or an electric valve, for example. One of the first atmospheric opening valve 15_1 and the second atmospheric opening valve 15_2 may also serve as the other. That is, one atmospheric opening valve that also serves as both the first atmospheric opening valve 15_1 and the second atmospheric opening valve 15_2 may be provided for the first tank 11_1 and the second tank 11_2 in common.

The liquid supply mechanism 10 described above supplies the first liquid inside the first tank 11_1 to the liquid ejecting head 50, and supplies the second liquid inside the second tank 11_2 to the liquid ejecting head 50, under the control of the control unit 20. Here, the liquid ejecting apparatus 100 operates the liquid supply mechanism 10 under the control of the control unit 20 so that a discharge process SD of discharging the ink from the first nozzle row LN1 and the second nozzle row LN2 as maintenance of the liquid ejecting head 50 can be performed.

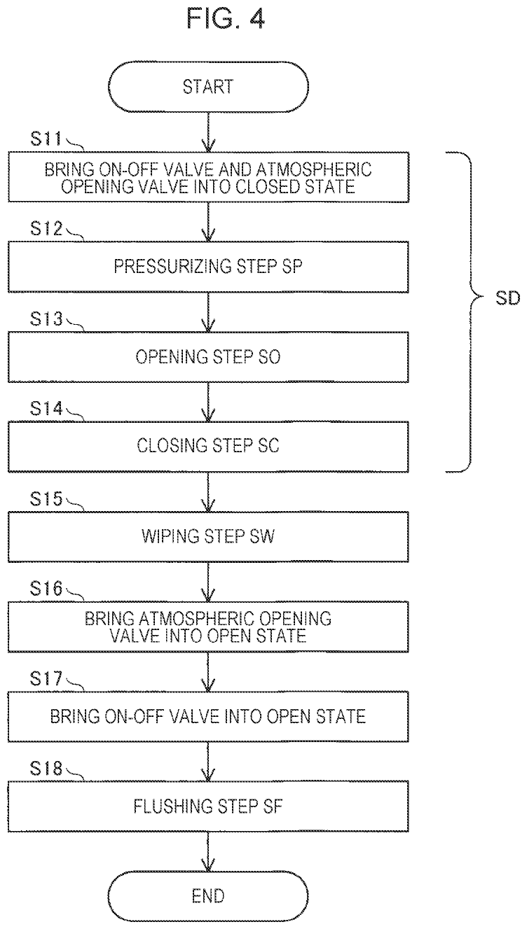

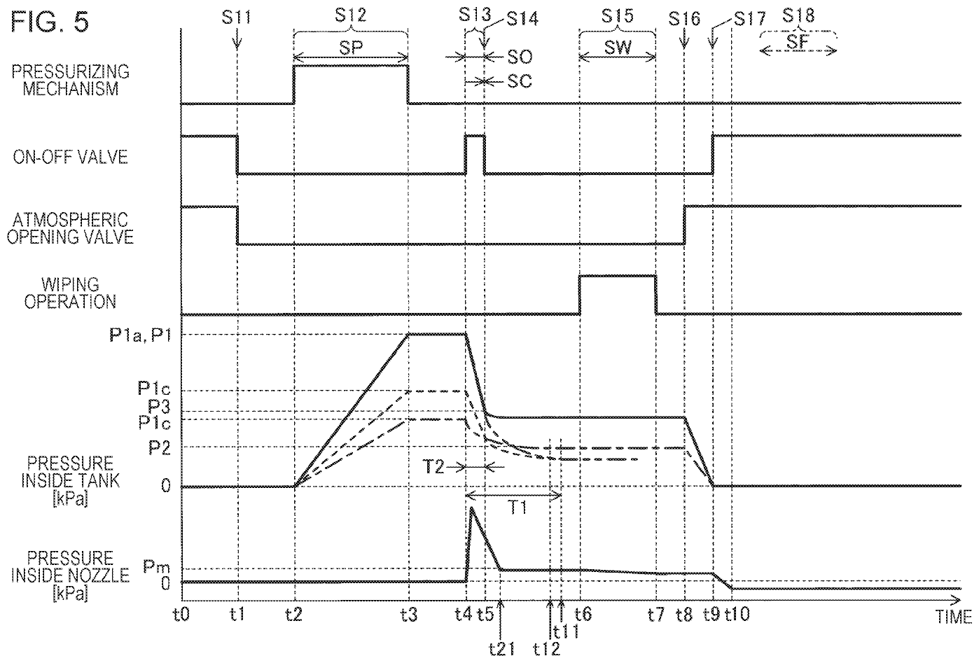

More specifically, the liquid ejecting apparatus 100 can perform one or both of a filling process of starting to perform the discharge process SD in a state where the liquid ejecting head 50 is not filled with the ink, and a cleaning process of starting to perform the discharge process SD in a state where the liquid ejecting head 50 is filled with the ink. Details of the discharge process SD will be described later with reference to FIGS. 4 and 5. The liquid ejecting apparatus 100 of the present embodiment can perform both the discharge process SD as the filling process and the discharge process SD as the cleaning process.

### 1-4. Operation of Liquid Ejecting Apparatus

FIG. 4 is a flowchart of a maintenance method for the liquid ejecting head 50 according to the first embodiment. Hereinafter, the maintenance method will be described with reference to FIG. 4. Hereinafter, each of the first supply flow path SJ_1 and the second supply flow path SJ_2 may be referred to as a supply flow path SJ in some cases. Each of the first tank 11_1 and the second tank 11_2 may be referred to as a tank 11 in some cases. Each of the first on-off valve 12_1 and the second on-off valve 12_2 may be referred to as an on-off valve 12 in some cases. Each of the first pressurizing mechanism 13_1 and the second pressurizing mechanism 13_2 may be referred to as a pressurizing mechanism 13 in some cases. Each of the first pressure sensor 14_1 and the second pressure sensor 14_2 may be referred to as a pressure sensor 14 in some cases. Each of the first atmospheric opening valve 15_1 and the second atmospheric opening valve 15_2 may be referred to as an atmospheric opening valve 15 in some cases.

In the maintenance method, as illustrated in FIG. 4, the control unit 20 performs Step S11 to Step S18 in this order. Here, the discharge process SD is performed from Step S11 to Step S14. Hereinafter, each step will be described in order.

First, in Step S11, the control unit 20 brings the on-off valve 12 and the atmospheric opening valve 15 into a closed state. Step S11 is omitted when the on-off valve 12 and the atmospheric opening valve 15 are in the closed state in advance.

After Step S11 above, in Step S12, the control unit 20 performs a pressurizing step SP. In the pressurizing step SP, a predetermined positive pressure is set by pressurizing the inside of the tank 11 in a closed state of the supply flow path SJ. Here, in the pressurizing step SP, the inside of the tank 11 is pressurized by driving the pressurizing mechanism 13 in a closed state of the on-off valve 12. In this case, since the supply flow path SJ is closed, the ink is not supplied to the liquid ejecting head 50.

In the pressurizing step SP of the present embodiment, the pressurizing mechanism 13 is driven in a closed state of the atmospheric opening valve 15. Therefore, the inside of the tank 11 can be efficiently pressurized. A change in the pressure inside the tank 11 will be described later with reference to FIG. 5.

After Step S12 above, in Step S13, the control unit 20 performs an opening step SO. In the opening step SO, after the pressurizing step SP, the supply flow path SJ is opened to discharge the ink from the nozzle row LN. Here, in the opening step SO, the on-off valve 12 is brought into an open state in a state where the pressure inside the tank 11 is set to a predetermined positive pressure. In this manner, the ink inside the tank 11 is supplied to the liquid ejecting head 50 via the supply flow path SJ by the pressure inside the tank 11.

The opening step SO of the present embodiment is performed after the pressurizing mechanism 13 is stopped in the pressurizing step SP. That is, before the on-off valve 12 is switched from the closed state to the open state in the opening step SO, the pressurizing mechanism 13 is stopped.

After Step S13 above, in Step S14, the control unit 20 performs a closing step SC. In the closing step SC, the supply flow path SJ is closed at a timing at which the ink is being continuously discharged from the nozzle row LN by the opening step SO. Here, in the closing step SC, the supply flow path SJ is closed by switching the on-off valve 12 from the open state to the closed state. In this manner, the supply of the ink from the tank 11 to the liquid ejecting head 50 via the supply flow path SJ is stopped.

In addition, from a viewpoint of improving efficiency of the discharge process SD or reducing contamination of the ink in the nozzle row LN, in the opening step SO, it is preferable that a period for maintaining the open state of the first supply flow path SJ_1 and a period for maintaining the open state of the second supply flow path SJ_2 at least partially overlap each other, and it is more preferable that these periods coincide with each other.

Here, the period for maintaining the open state of the first supply flow path SJ_1 is the period for maintaining the open state of the first on-off valve 12_1. The period for maintaining the open state of the second supply flow path SJ_2 is a period for maintaining the open state of the second on-off valve 12_2.

In addition, when the period for maintaining the open state of the first supply flow path SJ_1 and the period for maintaining the open state of the second supply flow path SJ_2 coincide with each other, a timing at which the first on-off valve 12_1 is switched from the closed state to the open state and a timing at which the second on-off valve 12_2 is switched from the closed state to the open state are the same as each other, and a timing at which the first on-off valve 12_1 is switched from the open state to the closed state and a timing at which the second on-off valve 12_2 is switched from the open state to the closed state is the same as each other.

After Step S14 above, in Step S15, the control unit 20 performs a wiping step SW. In the wiping step SW, after the closing step SC, that is, after the discharge process SD, a wiping operation for causing the wiping member 61 to wipe the ejecting surface FN is performed in a state where the supply flow path SJ is closed. Here, from a viewpoint of reducing contamination of the ink in the nozzle row LN, it is preferable that the wiping step SW is performed in a state where both the first supply flow path SJ_1 and the second supply flow path SJ_2 are closed. That is, it is preferable that the wiping step SW is performed during a period in which both the first on-off valve 12_1 and the second on-off valve 12_2 are in the closed state.

After Step S15 above, in Step S16, the control unit 20 switches the atmospheric opening valve 15 from the closed state to the open state. In this manner, the pressure inside the tank 11 becomes the atmospheric pressure. Step S16 may be performed while the wiping step SW is performed or before the wiping step SW is performed, as long as Step S16 is performed after the discharge process SD.

After Step S16 above, in Step S17, the control unit 20 switches the on-off valve 12 from the closed state to the open state. In this manner, since the pressure inside the tank 11 is the atmospheric pressure, the pressure of the ink in the nozzle row LN is reduced. Specifically, the pressure of the ink in the nozzle row LN is reduced to a pressure corresponding to a water head difference of the ink between the tank 11 and the liquid ejecting head 50.

In this way, the atmospheric opening valve 15 is switched from the closed state to the open state at a timing after the on-off valve 12 is brought into the closed state in the closing step SC and before the on-off valve 12 is brought into the open state after the wiping operation is performed. Here, the timing at which the atmospheric opening valve 15 is switched from the closed state to the open state may be a timing before at least one of the first on-off valve 12_1 and the second on-off valve 12_2 is brought into the open state after the wiping operation is performed. Here, when the timing at which the first on-off valve 12_1 is brought into the open state and the timing at which the second on-off valve 12_2 is brought into the open state after the wiping operation is performed are the same, “the timing before at least one of the first on-off valve 12_1 and the second on-off valve 12_2 is brought into the open state after the wiping operation is performed” is a timing before both the first on-off valve 12_1 and the second on-off valve 12_2 are brought into the open state. When the timing at which the first on-off valve 12_1 is brought into the open state and the timing at which the second on-off valve 12_2 is brought into the open state after the wiping operation is performed are different, “the timing before at least one of the first on-off valve 12_1 and the second on-off valve 12_2 is brought into the open state after the wiping operation is performed” is a timing before one on-off valve 12 brought into the open state earlier after the wiping operation is performed is brought into the open state in the first on-off valve 12_1 and the second on-off valve 12_2.

After Step S17, in Step S18, the control unit 20 performs a flushing process SF. In the flushing process SF, a flushing operation is performed after the wiping operation is performed. In the flushing operation, the ink is ejected from the nozzle N toward the liquid receiving member 62 in a state where the liquid ejecting head 50 is located at the home position. Here, the ink is ejected from the nozzle N by driving the drive element 51f of the liquid ejecting head 50.

In the flushing operation, from a viewpoint of suitably removing contamination of the ink in the nozzle N, the total amount of the ink ejected from one nozzle N in the plurality of nozzles N is preferably equal to or smaller than the volume of the pressure chamber C communicating with the one nozzle, is more preferably equal to or smaller than the volume of the communication flow path Na and the nozzle N which are flow paths downstream of the pressure chamber C, and is much more preferably equal to or smaller than the volume of the nozzle N.

As described above, the maintenance of the liquid ejecting head 50 is performed. Since the maintenance is performed, printing of the liquid ejecting head 50 is completely prepared. The flushing process SF in Step S18 may be performed and omitted when necessary.

FIG. 5 is a timing chart of a maintenance method (maintenance process) of the liquid ejecting head 50 according to the first embodiment. FIG. 5 illustrates operation states of the on-off valve 12, the pressurizing mechanism 13, the atmospheric opening valve 15, and the wiping operation during a period from timing t0 to timing t10, and changes in the pressure inside the tank 11 and the pressure inside the nozzle N. The timing chart of the pressurizing mechanism 13 indicates that the pressurizing mechanism 13 is in a driving state when a level is high, and indicates that the pressurizing mechanism 13 is in a non-driving state when the level is low. The timing chart of the on-off valve 12 indicates that the on-off valve 12 is in the open state when the level is high, and indicates that the on-off valve 12 is in the closed state when the level is low. The timing chart of the atmospheric opening valve 15 indicates that the atmospheric opening valve 15 is in the open state when the level is high, and indicates that the atmospheric opening valve 15 is in the closed state when the level is low. The timing chart of the wiping operation indicates that the wiping member 61 is in a state of wiping the ejecting surface FN when the level is high, and indicates that the wiping member 61 is not in a state of wiping the ejecting surface FN when the level is low. Depending on the configuration of the on-off valve 12, the on-off valve 12 may be in the closed state when the level is high, and the on-off valve 12 may be in the open state when the level is low. This also applies to the atmospheric opening valve 15.

First, the maintenance method including the discharge process SD as a filling process will be mainly described with reference to FIG. 5. In FIG. 5, a change in the pressure inside the tank 11 in the maintenance method including the discharge process SD as the filling process is illustrated by a solid line.

As illustrated in FIG. 5, when the on-off valve 12 and the atmospheric opening valve 15 are in the open state at timing t0 at which the maintenance process starts, each of the on-off valve 12 and the atmospheric opening valve 15 is in the closed state at timing t1 after timing t0 (Step S11). In this case, each of the pressurizing mechanism 13 and the wiping operation is in a stopped state. In addition, each pressure inside the tank 11 and inside the nozzle N is 0 kPa. The pressure in the present specification is described, based on a gauge pressure in which the atmospheric pressure is set to 0 kPa.

At timing t2 after timing t1, the driving of the pressurizing mechanism 13 is started, and at timing t3 after timing t2, the driving of the pressurizing mechanism 13 is stopped. That is, during a period from timing t2 to timing t3, the pressurizing mechanism 13 is driven over the period (Step S12). In this manner, since the pressurizing step SP is performed, the pressure inside the tank 11 rises to a first pressure P1 which is a predetermined positive pressure. In FIG. 5, the predetermined positive pressure inside the tank 11 after the pressurizing step SP is performed as the filling process is set as a first pressure P1a, and the predetermined positive pressure inside the tank 11 after the pressurizing step SP is performed as the cleaning process is set to a first pressure P1b. However, when the first pressure P1a and the first pressure P1b are not distinguished, both will be simply referred to as the first pressure P1. In an example illustrated in FIG. 5, the first pressure P1a is 41 kPa. When the liquid supply mechanism 10 includes a regulator coupled to the tank 11, the pressurizing mechanism 13 may not be stopped at timing t3. At timing t4 after timing t3, the on-off valve 12 is switched from the closed state to the open state (Step S13). In this manner, since the opening step SO is performed, the pressure inside the nozzle N sharply rises in accordance with a decrease in the pressure inside the tank 11. During a period from timing t3 to timing t4, the pressure inside the tank 11 is maintained at the first pressure P1.

At timing t5 after timing t4, the on-off valve 12 is switched from the open state to the closed state. In this manner, the closing step SC is performed (Step S14). In this way, during a period from timing t4 to timing t5, the on-off valve 12 is in the open state over the period. During the period, the ink is discharged from the nozzle N. In addition, even during a period from timing t5 to the timing 21 after timing t5, the ink is discharged from the nozzle N. As illustrated in FIG. 5, timing t21 is a timing at which the pressure inside the nozzle N reaches a meniscus withstand voltage Pm. That is, since the pressure inside the nozzle N at timing t5 is higher than the meniscus withstand voltage Pm of the nozzle N, timing t5 is a timing at which the ink is being continuously discharged from the nozzle N. The meniscus withstand voltage Pm in the example illustrated in FIG. 5 is 1 kPa.

In the example illustrated in FIG. 5, timing t5 is a timing at which the pressure inside the tank 11 reaches a third pressure P3. The third pressure P3 is a pressure between the first pressure P1 and a second pressure P2. Here, the second pressure P2 is the pressure inside the tank 11 when the on-off valve 12 is brought into the open state until the pressure inside the tank 11 becomes substantially constant after the pressure inside the tank 11 is set to the first pressure P1, in other words, when the on-off valve 12 is not switched from the open state to the closed state at timing t5 (hereinafter, referred to as a discharge process of Comparative Example 1). Here, “substantially constant” means that the pressure inside the tank 11 is in an equilibrium state, and more specifically, that a state where a maximum amplitude of the pressure is 1 kPa or lower is continued for 3 seconds or more. In FIG. 5, a change in the pressure inside the tank 11 in the discharge process as a filling process of Comparative Example 1 is illustrated by a two-dot chain line. That is, in the example illustrated in FIG. 5, the third pressure P3 is the pressure between the first pressure P1a and the second pressure P2. The second pressure P2 is 3 kPa, and the third pressure P3 is 19 kPa.

In addition, a time length required from timing t4 in Comparative Example 1 to timing t11 at which the pressure inside the tank 11 becomes substantially constant is defined as a first time length T1, and a length of a period from timing t4 to timing t5 is defined as a second time length T2, from a viewpoint of reducing waste of the ink discharged from the nozzle N, the second time length T2 is shorter than the first time length T1, is preferably equal to or shorter than half the first time length T1, is more preferably equal to or shorter than ⅓ of the first time length T1, and is much more preferably equal to or shorter than ⅕ of the first time length T1. In the example illustrated in FIG. 5, the second time length T2 is 2 seconds, and the first time length T1 is approximately 5 to 10 seconds. Although not illustrated, in Comparative Example 1, the pressure inside the nozzle N exceeds the meniscus withstand voltage Pm by bringing the on-off valve 12 into the open state at timing t4. Thereafter, during a period until timing t11 at which the pressure inside the nozzle N becomes the meniscus withstand voltage Pm, the pressure inside the nozzle N is higher than the meniscus withstand voltage Pm. Therefore, the ink is discharged from the nozzle N.

During a period from timing t6 to timing t7 after timing t5, the wiping operation is performed over the period (Step S15). Timing t6 is preferably after timing t21 at which the pressure inside the nozzle N reaches the meniscus withstand voltage Pm.

At timing t8 after timing t7, the atmospheric opening valve 15 is switched from the closed state to the open state (Step S16). In this manner, the pressure inside the tank 11 is lowered to the atmospheric pressure. From a viewpoint of shortening a process time of the maintenance process, the switching may be performed during a period in which the wiping operation is performed, that is, during a period from timing t6 to timing t7, or before the wiping operation is performed, that is, before timing t6.

At timing t9 after timing t8, the on-off valve 12 is switched from the closed state to the open state. In this manner, the supply of the ink from the tank 11 to the liquid ejecting head 50 via the supply flow path SJ is allowed. Thereafter, the flushing process SF is performed when necessary (Step S18).

Next, the maintenance method including the discharge process SD as the cleaning process will be described with reference to FIG. 5. In the present embodiment, with regard to the maintenance method including the discharge process SD as the filling process and the maintenance method including the discharge process SD as the cleaning process, substantially the same maintenance process is performed except that the first pressure P1 generated inside the tank 11 by the pressurizing step SP is different. Therefore, only a different point will be described. In FIG. 5, a change in the pressure inside the tank 11 in the maintenance method including the discharge process SD as the cleaning process is illustrated by a one-dot chain line. In FIG. 5, with regard to the maintenance process including the discharge process SD as the filling process, a change in the pressure inside the nozzle N, second pressure P2, the third pressure P3, and a two-dot chain line which is a change in the pressure inside the tank 11 in the discharge process of Comparative Example 1, timing t11, and the first time length T1 are illustrated, and the illustration of the maintenance process including the discharge process SD as the cleaning process is omitted.

When the liquid ejecting apparatus 100 can perform both the filling process and the cleaning process, as illustrated in FIG. 5, it is preferable that the first pressure P1b in the cleaning process is lower than the first pressure P1a in the filling process. In the example illustrated in FIG. 5, the first pressure P1b in the cleaning process is 15 kPa which is lower than the first pressure P1a in the filling process. In this manner, the filling process can be performed without any excess or deficiency of the ink, and the amount of the ink to be wastefully consumed in the cleaning process can be reduced. As can be understood from FIG. 5, in the present embodiment, a period during which the pressurizing mechanism 13 is driven in the pressurizing step SP of the filling process and a period during which the pressurizing mechanism 13 is driven in the pressurizing step SP of the cleaning process are the same period from timing t2 to timing t3. Therefore, in the pressurizing step SP of the cleaning process, the first pressure P1b is set to be lower than the first pressure P1a by setting an output of the pressurizing mechanism 13 per unit time to be lower than that of the pressurizing step SP of the filling process. However, the period during which the pressurizing mechanism 13 is driven in the pressurizing step SP of the cleaning process may be set to be shorter than the period during which the pressurizing mechanism 13 is driven in the pressurizing step SP for the filling process. In this manner, the first pressure P1b may be set to be lower than the first pressure P1a. In this case, the outputs per unit time of the pressurizing mechanism 13 in the pressurizing step SP may be the same between the cleaning process and the filling process, and the output in the cleaning process may be set to be smaller than the output in the filling process.

Here, the discharge process of Comparative Example 2 will be described. A change in the pressure inside the tank 11 illustrated by a broken line in FIG. 5 illustrates a change in the pressure inside the tank 11 in the discharge process of Comparative Example 2 as the filling process. The filling process of Comparative Example 2 is different from the filling process of the present embodiment in the following points. The first pressure Plc which is a predetermined positive pressure generated inside the tank 11 by the pressurizing step SP is lower than the first pressure P1a generated inside the tank 11 by the pressurizing step SP of the filling process of the present embodiment. The on-off valve 12 is in the open state until timing t12 at which the pressure inside the tank 11 becomes substantially constant after the on-off valve 12 is brought into the open state at timing t4 after the pressurizing step SP. In other words, the on-off valve 12 is not brought into the closed state while the ink is continuously discharged from the nozzle N. The first pressure Plc is set to a magnitude capable of filling all of the nozzles N forming the nozzle row LN with the ink by bringing the on-off valve 12 into the open state over a period from timing t4 to timing t12. In the example illustrated in FIG. 5, the first pressure Plc is 25 kPa.

The supply flow path SJ communicates with the plurality of nozzles N forming the nozzle row LN, and flow path resistance from the introduction port IH to each nozzle varies. Therefore, there is a variation in time until each of the nozzle N is filled with the ink after the on-off valve 12 is brought into the open state at timing t4. Therefore, in Comparative Example 2, the ink is wastefully discharged from the nozzles N filled with the ink before a timing at which all of the nozzles N are filled with the ink, in the plurality of nozzles N forming the nozzle row LN.

On the other hand, inclination of a pressure change inside the tank 11 during a period from timing t4 to timing t5 of the present embodiment is greater than inclination of a pressure change inside the tank 11 during a period from timing t4 to timing t5 of Comparative Example 2. Therefore, all of the nozzles N forming the nozzle row LN can be instantaneously filled with the ink. Therefore, the amount of the ink wastefully discharged from the nozzles N can be reduced, compared to Comparative Example 2.

Hitherto, the comparison between Comparative Example 2 and the present embodiment has been described with regard to the filling process. However, a relationship between the filling process of Comparative Example 2 and the filling process of the present embodiment is the same as a relationship between the cleaning process of Comparative Example 2 and the cleaning process of the present embodiment. Specifically, in the cleaning process of Comparative Example 2, there is a variation in time until a predetermined amount of the ink required for cleaning is discharged from each of the nozzles N after the on-off valve 12 is brought into the open state at timing t4. Therefore, in the cleaning process of Comparative Example 2, the ink is wastefully discharged from the nozzle N in which the predetermined amount of the ink is discharged before a timing at which the predetermined amount of the ink is discharged from all of the nozzles N, in the plurality of nozzles N forming the nozzle row LN. On the other hand, for the same reason as the filling process of the present embodiment, the cleaning process of the present embodiment can reduce the amount of the ink wastefully discharged from the nozzles N, compared to Comparative Example 2.

As in the filling process of Comparative Example 1 described above, the predetermined positive pressure generated inside the tank 11 by the pressurizing step SP is increased to an extent the same as that in the present embodiment. In this manner, it is conceivable that the plurality of nozzles N forming the nozzle row LN can be instantaneously filled with the ink. However, in the filling process of Comparative Example 1, the on-off valve 12 is not brought into the closed state at timing t5. Therefore, the positive pressure inside the tank 11 which is excessive with respect to the pressure required for filling all of the nozzles N forming the nozzle row LN with the ink acts on the liquid ejecting head 50. As a result, in the filling process of Comparative Example 1, the ink is wastefully discharged from the nozzles N, compared to the filling process of the present embodiment. The same applies to the cleaning process of Comparative Example 1, and the ink is wastefully discharged from the nozzle N, compared to the cleaning process of the present embodiment.

As described above, the liquid ejecting apparatus 100 includes the liquid ejecting head 50, the first tank 11_1, the first supply flow path SJ_1, the first on-off valve 12_1, and the first pressurizing mechanism 13_1. The liquid ejecting head 50 includes the first nozzle row LN1 for ejecting the first liquid. The first tank 11_1 stores the first liquid to be supplied to the first nozzle row LN1. The first supply flow path SJ_1 is a flow path for supplying the first liquid from the first tank 11_1 to the first nozzle row LN1. The first on-off valve 12_1 is provided in the intermediate portion of the first supply flow path SJ_1, and can open and close the first supply flow path SJ_1. The first pressurizing mechanism 13_1 can pressurize the inside of the first tank 11_1.

Moreover, the liquid ejecting apparatus 100 can perform the discharge process SD. In the discharge process SD, the pressure inside the first tank 11_1 is set to the predetermined positive pressure by driving the first pressurizing mechanism 13_1 in the closed state of the first on-off valve 12_1. Thereafter, the first liquid is discharged from the first nozzle row LN1 by bringing the first on-off valve 12_1 into the open state. Here, in the discharge process SD, the first on-off valve 12_1 is switched from the open state to the closed state at a timing at which the first liquid is being continuously discharged from the first nozzle row LN1.

In the above-described liquid ejecting head 50, in the discharge process SD, the pressure inside the first tank 11_1 is set to the predetermined positive pressure by driving the first pressurizing mechanism 13_1 in the closed state of the first on-off valve 12_1. Thereafter, the first on-off valve 12_1 is brought into the open state. Therefore, the first liquid can be supplied to the liquid ejecting head 50 while the pressure for supplying the first liquid to the first nozzle row LN1 is sharply raised. Therefore, the liquid can be instantaneously distributed to all of the nozzles N forming the first nozzle row LN1. In addition, in the discharge process SD, the first on-off valve 12_1 is switched from the open state to the closed state at a timing at which the first liquid is being continuously discharged from the first nozzle row LN1. Therefore, it is possible to shorten a period in which the first liquid is unnecessarily discharged from the first nozzle row LN1. Therefore, the first liquid is prevented from being wastefully discharged from the first nozzle row LN1.

As described above, in the discharge process SD, the first on-off valve 12_1 is switched from the open state to the closed state at timing t5 at which the pressure inside the first tank 11_1 reaches the third pressure P3. Here, the third pressure P3 is the pressure between the first pressure P1 and the second pressure P2. The first pressure P1 is the predetermined positive pressure. The second pressure P2 is the pressure inside the first tank 11_1 when the first on-off valve 12_1 is brought into the open state until the pressure inside the first tank 11_1 becomes substantially constant after the pressure inside the first tank 11_1 is set to the first pressure P1. In this discharge process SD, the amount of the first liquid to be wasted can be reduced.

In addition, as described above, timing t5 is the timing at which the second time length T2 elapses after the first on-off valve 12_1 is brought into the open state in the discharge process SD. That is, in the discharge process SD, the first on-off valve 12_1 is switched from the open state to the closed state at timing t5 at which the second time length T2 elapses after the first on-off valve 12_1 is brought into the open state. Here, the second time length T2 is shorter than the first time length T1. The first time length T1 is the time length required until the pressure inside the first tank 11_1 becomes substantially constant after the first on-off valve 12_1 is brought into the open state when the first on-off valve 12_1 is brought into the open state until the pressure inside the first tank 11_1 becomes substantially constant after the pressure inside the first tank 11_1 is set to the first pressure P1. In this manner, the amount of the first liquid to be wasted can be reduced.

Furthermore, as described above, it is preferable that the second time length T2 is equal to or shorter than half the first time length T1. In this case, in the discharge process SD, the amount of the first liquid to be wastefully consumed can be suitably reduced.

In addition, as described above, the liquid ejecting apparatus 100 can perform one or both of the filling process of starting to perform the discharge process SD in a state where the liquid ejecting head 50 is not filled with the first liquid, and the cleaning process of starting to perform the discharge process SD in a state where the liquid ejecting head 50 is filled with the first liquid. Therefore, the amount of the first liquid to be wasted can be reduced in one or both of the filling process and the cleaning process.

Furthermore, as described above, when the liquid ejecting apparatus 100 can perform both the filling process and the cleaning process, the predetermined positive pressure in the cleaning process is lower than the predetermined positive pressure in the filling process. In the filling process, in order to replace the air inside the liquid ejecting head 50 with the liquid, it is necessary to increase the pressure inside the first tank 11_1, compared to the cleaning process. In addition, when a filter (not illustrated) is disposed in the intermediate portion of the first supply flow path SJ_1, in order to exceed a bubble point of the filter in the filling process, in this respect as well, it is necessary to increase the pressure inside the first tank 11_1, compared to the cleaning process. Therefore, the pressure inside the first tank 11_1 in the cleaning process is decreased, compared to the pressure inside the first tank 11_1 in the filling process. In this manner, the filling process can be performed without any excess or deficiency of the liquid, and the amount of the liquid wastefully consumed in the cleaning process can be reduced.

Furthermore, as described above, the liquid ejecting apparatus 100 includes the first atmospheric opening valve 15_1 that can open and close the inside of the first tank 11_1 to be open to the atmosphere. In the discharge process SD, the inside of the first tank 11_1 is pressurized to the predetermined positive pressure by driving the first pressurizing mechanism 13_1 in a closed state of the first atmospheric opening valve 15_1. Therefore, the inside of the first tank 11_1 can be efficiently pressurized to the predetermined positive pressure by driving the first pressurizing mechanism 13_1 in the closed state of the first atmospheric opening valve 15_1. In addition, when necessary, the inside of the first tank 11_1 can be set to the atmospheric pressure by opening the inside of the first tank 11_1 to the atmosphere. In this manner, for example, the pressure corresponding to a water head difference between the first tank 11_1 and the liquid ejecting head 50 can act on the ink of the nozzle N.

In addition, as described above, in the discharge process SD, the first pressurizing mechanism 13_1 is stopped before the first on-off valve 12_1 is switched from the closed state to the open state. Therefore, even when the first pressurizing mechanism 13_1 is stopped, the pressure inside the first tank 11_1 can be maintained at the predetermined positive pressure. As a result, power saving can be achieved.

Furthermore, as described above, the liquid ejecting head 50 includes the ejecting surface FN including the first nozzle row LN1 and the second nozzle row LN2 for ejecting the second liquid having a type different from a type of the first liquid. The liquid ejecting apparatus 100 includes the second tank 11_2, the second supply flow path SJ_2, the second on-off valve 12_2, and the second pressurizing mechanism 13_2. The second tank 11_2 stores the second liquid to be supplied to the second nozzle row LN2. The second supply flow path SJ_2 is a flow path for supplying the second liquid from the second tank 11_2 to the second nozzle row LN2. The second on-off valve 12_2 is provided in the intermediate portion of the second supply flow path SJ_2, and can open and close the second supply flow path SJ_2. The second pressurizing mechanism 13_2 can pressurize the inside of the second tank 11_2.

Moreover, in the discharge process SD, the pressure inside the second tank 11_2 is set to the predetermined positive pressure by driving the second pressurizing mechanism 13_2 in the closed state of the second on-off valve 12_2, and thereafter, the second liquid is discharged from the second nozzle row LN2 by bringing the second on-off valve 12_2 into the open state. Here, in the discharge process SD, the second on-off valve 12_2 is switched from the open state to the closed state at a timing at which the second liquid is being continuously discharged from the second nozzle row LN2. Moreover, in the discharge process SD, the period for maintaining the open state of the first on-off valve 12_1 and the period for maintaining the open state of the second on-off valve 12_2 at least partially overlap each other. That is, the period from timing t4 to timing t5 of the discharge process SD corresponding to the first nozzle row LN1 and the period from timing t4 to timing t5 of the discharge process SD corresponding to the second nozzle row LN2 at least partially overlap each other. Therefore, when the liquid is discharged from the plurality of nozzle rows LN that eject mutually different types of the liquid in the discharge process SD, each internal pressure of the plurality of nozzle rows LN can be set to a positive pressure. As a result, it is possible to reduce a risk that the first liquid inside the nozzle N of the first nozzle row LN1 may be contaminated by the second liquid mixed into the nozzle N of the first nozzle row LN1, and a risk that the second liquid inside the nozzle N of the second nozzle row LN2 may be contaminated by the first liquid mixed into the nozzle N of the second nozzle row LN2.

In addition, as described above, in the discharge process SD, the timing at which the first on-off valve 12_1 is switched from the closed state to the open state and the timing at which the second on-off valve 12_2 is switched from the closed state to the open state are the same as each other. The timing at which the first on-off valve 12_1 is switched from the open state to the closed state and the timing at which the second on-off valve 12_2 is switched from the open state to the closed state are the same as each other. Therefore, contamination of the liquid in the first nozzle row LN1 and the second nozzle row LN2 can be further reduced.

Furthermore, as described above, the liquid ejecting apparatus 100 further includes the wiping member 61 that wipes the ejecting surface FN. The liquid ejecting apparatus 100 causes the wiping member 61 to perform the wiping operation for wiping the ejecting surface FN during a period in which both the first on-off valve 12_1 and the second on-off valve 12_2 are in the closed state after the discharge process SD. Therefore, since the wiping operation is performed in a state where each internal pressure of the first nozzle row LN1 and the second nozzle row LN2 is the positive pressure, the contamination of the liquid in the first nozzle row LN1 and the second nozzle row LN2 can be suitably reduced.

In addition, as described above, the liquid ejecting apparatus 100 further includes the first atmospheric opening valve 15_1 that can open and close the inside of the first tank 11_1 to be open to the atmosphere, and the second atmospheric opening valve 15_2 that can open and close the inside of the second tank 11_2 to be open to the atmosphere. In the liquid ejecting apparatus 100, after both the first on-off valve 12_1 and the second on-off valve 12_2 are brought into the closed state in the discharge process SD, and at the timing before at least one of the first on-off valve 12_1 and the second on-off valve 12_2 is brought into the open state after the wiping operation is performed, both the first atmospheric opening valve 15_1 and the second atmospheric opening valve 15_2 are switched from the closed state to the open state. Therefore, at the time at which the first on-off valve 12_1 and the second on-off valve 12_2 are brought into the open state, the positive pressure remaining inside the tank 11 by the closing step SC acts on the first nozzle row LN1 and the second nozzle row LN2. In this manner, it is possible to prevent the ink from being wastefully discharged from the nozzle N.

Furthermore, as described above, the liquid ejecting apparatus 100 may switch the first atmospheric opening valve 15_1 and the second atmospheric opening valve 15_2 from the closed state to the open state, while the wiping operation is performed or before the wiping operation is performed. In this case, it is possible to shorten a time required for printing preparation including the filling process or a time required for the cleaning process.

In addition, as described above, the first nozzle row LN1 includes the plurality of nozzles N. The liquid ejecting head 50 includes the plurality of pressure chambers C communicating with every nozzle of the plurality of nozzles N. The liquid ejecting apparatus 100 performs the flushing operation after the wiping operation is performed. Here, the total amount of the first liquid ejected from one nozzle N of the plurality of nozzles N by the flushing operation is equal to or smaller than the volume of the pressure chamber C communicating with the one nozzle of the plurality of pressure chambers C. Since the liquid inside the nozzle N is less contaminated by the discharge process SD and the wiping step SW described above, it is sufficient to discharge the liquid inside the nozzle N by performing the flushing operation on only the vicinity of the meniscus surface of the liquid inside the nozzle N. Therefore, contamination on the meniscus surface of the first liquid inside the nozzle N can be removed with a small amount of the ink.

In addition, as described above, the first nozzle row LN1 and the second nozzle row LN2 are provided in the same nozzle plate 51c. In this case, an effect of reducing the contamination of the liquid in the nozzle row LN is remarkable.

Furthermore, as described above, the shortest distance between the nozzles of the first nozzle row LN1 and the second nozzle row LN2 is preferably 1.5 mm or shorter. In this configuration in which the shortest distance Dn is relatively short, the liquid discharged from one nozzle row LN of the first nozzle row LN1 and the second nozzle row LN2 moves to the other nozzle row LN. Consequently, the liquid inside the nozzle N is likely to be contaminated. Therefore, in this case, the effect of reducing the contamination of the liquid in the nozzle row LN by the discharge process SD and the wiping step SW described above is remarkable.

In addition, as described above, the maintenance method for the liquid ejecting head 50 includes the pressurizing step SP, the opening step SO, and the closing step SC. In the pressurizing step SP, the inside of the first tank 11_1 is pressurized in the closed state of the first supply flow path SJ_1 for supplying the first liquid to the first nozzle row LN1 from the first tank 11_1 storing the first liquid to be supplied to the first nozzle row LN1. In the opening step SO, after the pressurizing step SP, the first liquid is discharged from the first nozzle row LN1 by opening the first supply flow path SJ_1. In the closing step SC, the first supply flow path SJ_1 is closed at a timing at which the first liquid is being continuously discharged from the first nozzle row LN1 by the opening step SO.

In the above-described maintenance method for the liquid ejecting head 50, the above-described discharge process SD is performed. Therefore, while the first liquid is prevented from being wastefully discharged from the first nozzle row LN1, the liquid can be distributed to all of the nozzles N forming the first nozzle row LN1 in a short time.

Here, as described above, in the pressurizing step SP, the inside of the second tank 11_2 is pressurized in the closed state of the second supply flow path SJ_2 for supplying the second liquid to the second nozzle row LN2 from the second tank 11_2 storing the second liquid to be supplied to the second nozzle row LN2. In the opening step SO, the second liquid is discharged from the second nozzle row LN2 by opening the second supply flow path SJ_2. In the closing step SC, the second supply flow path SJ_2 is closed at a timing at which the second liquid is being continuously discharged from the second nozzle row LN2 by the opening step SO. Moreover, in the opening step SO, the period for maintaining the open state of the first supply flow path SJ_1 and the period for maintaining the open state of the second supply flow path SJ_2 at least partially overlap each other. Therefore, when the liquid is discharged from the plurality of nozzle rows LN that eject mutually different types of the liquid in the discharge process SD, each internal pressure of the plurality of nozzle rows LN can be set to a positive pressure. As a result, contamination of the liquid in the first nozzle row LN1 and the second nozzle row LN2 can be suitably reduced.

In addition, as described above, the maintenance method for the liquid ejecting head 50 further includes the wiping step SW for causing the wiping member 61 to wipe the ejecting surface FN in the closed state of both the first supply flow path SJ_1 and the second supply flow path SJ_2 after the closing step SC. Therefore, the wiping step SW is performed in a state where each internal pressure of the first nozzle row LN1 and the second nozzle row LN2 is the positive pressure. Therefore, contamination of the liquid in the first nozzle row LN1 and the second nozzle row LN2 can be suitably reduced.

### 2. Modification Example of First Embodiment

In the first embodiment, as illustrated in FIG. 5, the second time length T2 which is the length of the period during which the opening step SO included in the filling process is performed, and the second time length T2 which is the length of the period during which the opening step SO included in the cleaning process is performed are the same length. However, the embodiment is not limited to this configuration.

Here, in a first modification example of the first embodiment, a time length T2b (not illustrated) which is the length of the period during which the opening step SO included in the cleaning process is performed may be shorter than a time length T2a (not illustrated) which is the length of the period during which the opening step SO included in the filling process is performed. In this manner, as in the first embodiment, the filling process can be performed without any excess or deficiency of the ink, and the amount of the ink to be wastefully consumed in the cleaning process can be reduced. In the first embodiment, the first pressure P1b which is the predetermined positive pressure inside the tank 11 after the pressurizing step SP is performed as the cleaning process is lower than the first pressure P1a which is the predetermined positive pressure inside the tank 11 after the pressurizing step SP is performed as the filling process. However, in the modification example of the first embodiment, the first pressure P1b may be lower than the first pressure P1a as in the first embodiment. Alternatively, the first pressure P1b and the first pressure P1a may be the same as each other.

As described above, when the liquid ejecting apparatus 100 can perform both the filling process and the cleaning process, the time length T2b from the open state to the closed state of the first on-off valve 12_1 in the cleaning process is shorter than the time length T2a from the open state to the closed state of the first on-off valve 12_1 in the filling process. Therefore, the filling process can be performed without any excess or deficiency of the liquid, and the amount of the liquid to be wastefully consumed in the cleaning process can be reduced.

### 3. Second Embodiment

Hereinafter, a second embodiment of the present disclosure will be described. In the embodiment described below as an example, the reference numerals used in the description of the first embodiment will be assigned to elements having the same effects and functions as those of the first embodiment, and each detailed description thereof will be appropriately omitted.

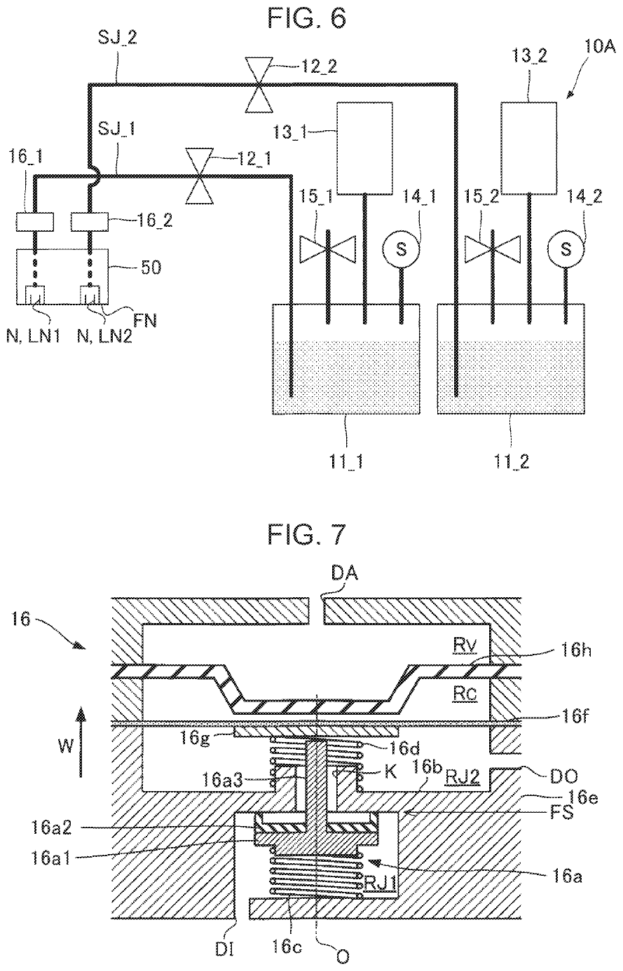

FIG. 6 is a schematic view of a liquid supply mechanism 10A of the second embodiment. The present embodiment is the same as the above-described first embodiment except that the liquid supply mechanism 10A is used instead of the liquid supply mechanism 10.

The liquid supply mechanism 10A is configured in the same manner as the liquid supply mechanism 10 of the first embodiment except that pressure regulating valves 16_1 and 16_2 are added.

The pressure regulating valve 16_1 is provided between the first on-off valve 12_1 of the first supply flow path SJ_1 and the liquid ejecting head 50, and is opened and closed in response to the pressure of the ink inside the liquid ejecting head 50. On the other hand, the pressure regulating valve 16_2 is provided between the second on-off valve 12_2 of the second supply flow path SJ_2 and the liquid ejecting head 50, and is opened and closed in response to the pressure of the ink inside the liquid ejecting head 50. Each of the pressure regulating valve 16_1 and the pressure regulating valve 16_2 is configured to be forcibly brought into an open state regardless of the pressure inside the liquid ejecting head 50.

FIG. 7 is a cross-sectional view illustrating an example of a pressure regulating valve 16. As illustrated in FIG. 7, the pressure regulating valve 16 includes an upstream flow path RJ1 and a downstream flow path RJ2, which form a part of the supply flow path SJ. The upstream flow path RJ1 is provided with an inlet DI of the ink, and the downstream flow path RJ2 is provided with an outlet DO of the ink. The ink from the tank 11 flows into the inlet DI. The outlet DO discharges the ink to be supplied to the liquid ejecting head 50.

The pressure regulating valve 16 includes a valve body 16a, a valve seat 16b, a spring 16c, and a spring 16d. The valve body 16a opens and closes the upstream flow path RJ1 by moving in a W-direction or a direction opposite thereto in the drawing to be closer to or separated from the valve seat 16b.

The valve seat 16b is a portion of a support body 16e which is located between the upstream flow path RJ1 and the downstream flow path RJ2, and faces a portion of a flexible film 16f that seals the downstream flow path RJ2 at an interval. A through-hole K penetrating the support body 16e is provided at substantially the center of the valve seat 16b. The upstream flow path RJ1 and the downstream flow path RJ2 communicate with each other via the through-hole K.

The valve body 16a is installed inside the upstream flow path RJ1. The valve body 16a includes a base portion 16a1, a sealing portion 16a2, and a valve shaft 16a3. The base portion 16a1 is a circular flat plate portion having an outer diameter larger than the inner diameter of the through-hole K. The valve shaft 16a3 coaxially and vertically projects on a surface of the base portion 16a1, and the annular sealing portion 16a2 is installed to surround the valve shaft 16a3 in a plan view. The base portion 16a1 and the sealing portion 16a2 are located inside the upstream flow path RJ1 in a state where an axis O of the valve shaft 16a3 is parallel to the W-direction and the valve shaft 16a3 is inserted into the through-hole K of the valve seat 16b. A gap is formed between an inner peripheral surface of the through-hole K of the valve seat 16b and an outer peripheral surface of the valve shaft 16a3. The spring 16c is installed inside the upstream flow path RJ1 between a surface of the support body 16e facing the valve seat 16b and the base portion 16a1 of the valve body 16a, and biases the valve body 16a toward the valve seat 16b. On the other hand, the spring 16d is installed inside the downstream flow path RJ2 between the valve seat 16b and a pressure receiving plate 16g. The sealing portion 16a2 of the valve body 16a is located between the base portion 16a1 and the valve seat 16b, and functions as a seal for closing the through-hole K by coming into contact with a sealing surface FS of the valve seat 16b.

An atmospheric pressure chamber RC communicating with an external space of the atmospheric pressure is adjacent to the downstream flow path RJ2 via a flexible film 16f. The flexible film 16f is a flexible elastic film, and is made of a film, rubber, or fibers, for example. As illustrated in FIG. 7, when the pressure inside the downstream flow path RJ2 is maintained within a predetermined range, the sealing portion 16a2 of the valve body 16a is pressed against the sealing surface FS of the valve seat 16b by a biasing force of the spring 16d. In this manner, the upstream flow path RJ1 and the downstream flow path RJ2 are blocked from each other. On the other hand, when the pressure inside the downstream flow path RJ2 is equal to or lower than a predetermined negative pressure, the sealing portion 16a2 of the valve body 16a is separated from the sealing surface FS of the valve seat 16b against the biasing force of the spring 16c and the spring 16d. In this manner, the upstream flow path RJ1 and the downstream flow path RJ2 communicate with each other. That is, the pressure regulating valve 16 is configured to set the pressure of the ink inside the liquid ejecting head 50 to the predetermined negative pressure so that the meniscus of the ink which enables the ink to be ejected from the nozzle N is formed inside the nozzle N.

In the pressure regulating valve 16, a pressure regulating chamber RV is adjacent to the atmospheric pressure chamber RC via an elastic member 16h. The elastic member 16h is a plate-shaped flexible member, and is made of an elastic material such as rubber. The pressure regulating chamber RV communicates with a gas flow path port DA. A pump (not illustrated) is coupled to the gas flow path port DA. The pump is a pump that can pressurize the pressure regulating chamber RV under the control of the control unit 20. Since the pump pressurizes the pressure regulating chamber RV, the elastic member 16h can be bent and deformed to be pressed toward the flexible film 16f As a result, the sealing portion 16a2 of the valve body 16a can be separated from the sealing surface FS of the valve seat 16b against the biasing force of the spring 16c and the spring 16d. In this way, without depending on the pressure of the downstream flow path RJ2, the upstream flow path RJ1 and the downstream flow path RJ2 can communicate with each other by an operation of the pump.

The pressure regulating valve 16 described above is forcibly brought into the open state over the period of the above-described discharge process SD. In this manner, the same discharge process SD as that in the first embodiment can be performed. In addition, it is preferable that the pressure regulating valve 16 is forcibly brought into the open state even during a period until the wiping step SW is completed after the discharge process SD is performed. In this manner, it is possible to reduce a possibility that the liquid inside the nozzle N may be contaminated during the wiping operation. The forcible open state of the pressure regulating valve 16 is stopped after the wiping step SW is completed and at a timing before timing t9 at which the on-off valve 12 is switched from the closed state to the open state in Step S17. In this manner, the ink can be appropriately supplied from the tank 11 to the liquid ejecting head 50 in response to the pressure inside the liquid ejecting head 50.

According to the second embodiment described above, in the discharge process SD, the amount of the liquid to be wastefully consumed can also be reduced. A configuration of the pressure regulating valve 16 is not limited to an example illustrated in FIG. 7. For example, the pressure regulating valve 16 may be configured to be forcibly brought into the open state by using a mechanism such as a cam to bend and deform the elastic member 16h.

### 4. Modification Examples

Each form described above as an example can be modified in various ways. Specific modification aspects will be described below as examples. Any two or more aspects selected from the following examples can be combined as appropriate within a mutually consistent range.

### 4-1. Modification Example 1

In the above-described form, an aspect in which the first liquid and the second liquid which have types different from each other are used has been described as an example. However, without being limited to this aspect, for example, one type, three, or more types of the liquid may be used. When one type of the liquid is used, the one type of the liquid corresponds to the “first liquid”. When three or more types of the liquid are used, one of two types of the liquid selected in any way from the three types of the liquid corresponds to the “first liquid”, and the other corresponds to the “second liquid”. In addition, the types of the liquid may be different for every head chip 51.

### 4-2. Modification Example 2

In the above-described form, an aspect in which the pressurizing mechanism 13 is directly coupled to the tank 11 has been described as an example. However, without being limited to this aspect, for example, the pressurizing mechanism 13 may be coupled to a portion between the tank 11 of the supply flow path SJ and the on-off valve 12.

### 4-3. Modification Example 3

In the above-described form, an aspect in which the pressurizing mechanism 13 pressurizes the inside of the tank 11 by introducing the gas into the tank 11 has been described as an example. However, without being limited to this aspect, for example, when the tank 11 is a flexible bag body, the pressurizing mechanism 13 may be configured to pressurize the inside of the tank 11 by pressing the tank 11 from the outside.

### 4-4. Modification Example 4

The liquid ejecting apparatus may be configured to circulate the first liquid or the second liquid inside or outside the liquid ejecting head 50. However, from a viewpoint of reducing a usage amount of the liquid as much as possible, such as when the first liquid or the second liquid is expensive, it is preferable to adopt a configuration in which the first liquid or the second liquid is not circulated in this way.

### 4-5. Modification Example 5

In the above-described form, the pressure of the ink inside the liquid ejecting head 50 is regulated to have the predetermined negative pressure by either the water head difference between the tank 11 and the liquid ejecting head 50 or the pressure regulating valve 16. However, a configuration for regulating the pressure of the ink inside the liquid ejecting head 50 is not limited to the above-described configurations. For example, the pressure of the ink inside the liquid ejecting head 50 may be regulated by driving the pressurizing mechanism 13, based on information on the pressure inside the tank 11 which is measured by the pressure sensor 14.

### 4-6. Modification Example 6

In the above-described form, the on-off valve 12 is disposed in the intermediate portion of the supply flow path SJ disposed outside the liquid ejecting head 50. However, the present disclosure is not limited thereto. The on-off valve 12 may be disposed inside the liquid ejecting head 50, that is, in the intermediate portion of the supply flow path SJ formed inside the liquid ejecting head 50.

### 4-7. Modification Example 7

The liquid ejecting apparatus 100 described as an example in each of the above-described embodiments can be adopted for various apparatuses such as a facsimile machine and a copier, in addition to an apparatus dedicated to printing. However, an application of the liquid ejecting apparatus of the embodiments of the present disclosure is not limited to the printing. For example, a liquid ejecting apparatus that ejects a solution or dispersing liquid of a coloring material as the first liquid or the second liquid is used as a manufacturing apparatus for forming a color filter of a liquid crystal display device. In addition, a liquid ejecting apparatus that ejects a solution or a dispersing liquid of a conductive material as the first liquid or the second liquid is used as a manufacturing apparatus for forming wiring or an electrode of a wiring substrate.

What is claimed is:

1. A liquid ejecting apparatus comprising:
a liquid ejecting head having a first nozzle row that ejects a first liquid;
a first tank storing the first liquid to be supplied to the first nozzle row;
a first supply flow path for supplying the first liquid to the first nozzle row from the first tank;
a first on-off valve provided in an intermediate portion of the first supply flow path and configured to open and close the first supply flow path; and
a first pressurizing mechanism configured to pressurize an inside of the first tank, wherein
in a closed state of the first on-off valve, the first pressurizing mechanism is driven to set a pressure inside the first tank to a predetermined positive pressure, and thereafter, the first on-off valve is brought into an open state to perform a discharge process of discharging the first liquid from the first nozzle row, and
in the discharge process, the first on-off valve is switched from the open state to the closed state at a timing at which the first liquid is being continuously discharged from the first nozzle row.

2. The liquid ejecting apparatus according to claim 1, wherein
when the predetermined positive pressure is set to a first pressure, a pressure inside the first tank when the first on-off valve is brought into the open state until the pressure inside the first tank is substantially constant after the pressure inside the first tank is set to the first pressure is set to a second pressure, and a pressure between the first pressure and the second pressure is set to a third pressure, in the discharge process, the first on-off valve is switched from the open state to the closed state at a timing at which the pressure inside the first tank is the third pressure.

3. The liquid ejecting apparatus according to claim 1, wherein
when the predetermined positive pressure is set to a first pressure, a time length required until the pressure inside the first tank is substantially constant after the first on-off valve is brought into the open state is set to a first time length in a case where the first on-off valve is brought into the open state until the pressure inside the first tank is substantially constant after the pressure inside the first tank is set to the first pressure, and a time length shorter than the first time length is set to a second time length, in the discharge process, the first on-off valve is switched from the open state to the closed state at a timing at which the second time length elapses after the first on-off valve is brought into the open state.

4. The liquid ejecting apparatus according to claim 3, wherein
the second time length is equal to or shorter than half the first time length.

5. The liquid ejecting apparatus according to claim 1, wherein
the liquid ejecting apparatus is configured to perform one or both of a filling process of starting to perform the discharge process in a state where the liquid ejecting head is not filled with the first liquid, and a cleaning process of starting to perform the discharge process in a state where the liquid ejecting head is filled with the first liquid.

6. The liquid ejecting apparatus according to claim 5, wherein
the liquid ejecting apparatus is configured to perform both the filling process and the cleaning process, and
the predetermined positive pressure in the cleaning process is smaller than the predetermined positive pressure in the filling process.

7. The liquid ejecting apparatus according to claim 5, wherein
the liquid ejecting apparatus is configured to perform both the filling process and the cleaning process, and
a time length required from the open state to the closed state of the first on-off valve in the cleaning process is shorter than a time length required from the open state to the closed state of the first on-off valve in the filling process.

8. The liquid ejecting apparatus according to claim 1, further comprising:
a first atmospheric opening valve configured to open and close the inside of the first tank to be open to the atmosphere, wherein
in the discharge process, the inside of the first tank is pressurized to the predetermined positive pressure by driving the first pressurizing mechanism in a closed state of the first atmospheric opening valve.

9. The liquid ejecting apparatus according to claim 8, wherein
in the discharge process, the first pressurizing mechanism is stopped before the first on-off valve is switched from the closed state to the open state.

10. The liquid ejecting apparatus according to claim 1, wherein
the liquid ejecting head includes an ejecting surface including the first nozzle row and a second nozzle row that ejects a second liquid having a type different from a type of the first liquid,
the liquid ejecting apparatus further comprises:
a second tank storing the second liquid to be supplied to the second nozzle row;
a second supply flow path for supplying the second liquid to the second nozzle row from the second tank;
a second on-off valve provided in an intermediate portion of the second supply flow path and configured to open and close the second supply flow path; and
a second pressurizing mechanism configured to pressurize an inside of the second tank,
in the discharge process, a pressure inside the second tank is set to a predetermined positive pressure by driving the second pressurizing mechanism in a closed state of the second on-off valve, and thereafter, the second liquid is discharged from the second nozzle row by bringing the second on-off valve into an open state,
in the discharge process, the second on-off valve is switched from the open state to the closed state at a timing at which the second liquid is being continuously discharged from the second nozzle row, and
in the discharge process, a period for maintaining the open state of the first on-off valve and a period for maintaining the open state of the second on-off valve at least partially overlap each other.

11. The liquid ejecting apparatus according to claim 10, wherein
in the discharge process, a timing at which the first on-off valve is switched from the closed state to the open state and a timing at which the second on-off valve is switched from the closed state to the open state are the same as each other, and
a timing at which the first on-off valve is switched from the open state to the closed state and a timing at which the second on-off valve is switched from the open state to the closed state are the same as each other.

12. The liquid ejecting apparatus according to claim 10, further comprising:
a wiping member that wipes the ejecting surface, wherein
after the discharge process, a wiping operation of causing the wiping member to wipe the ejecting surface is performed during a period in which both the first on-off valve and the second on-off valve are brought into the closed state.

13. The liquid ejecting apparatus according to claim 12, further comprising:
a first atmospheric opening valve configured to open and close the inside of the first tank to be open to the atmosphere; and
a second atmospheric opening valve configured to open and close the inside of the second tank to be open to the atmosphere, wherein
in the discharge process, after both the first on-off valve and the second on-off valve are brought into the closed state, and at a timing before at least one of the first on-off valve and the second on-off valve is brought into the open state after the wiping operation is performed, both the first atmospheric opening valve and the second atmospheric opening valve are switched from the closed state to the open state.

14. The liquid ejecting apparatus according to claim 13, wherein
during a period in which the wiping operation is performed or before the wiping operation is performed, the first atmospheric opening valve and the second atmospheric opening valve are switched from the closed state to the open state.

15. The liquid ejecting apparatus according to claim 12, wherein
the first nozzle row includes a plurality of nozzles,
the liquid ejecting head includes a plurality of pressure chambers communicating with every nozzle of the plurality of nozzles,
after the wiping operation is performed, a flushing operation is performed, and
a total amount of the first liquid ejected from one nozzle of the plurality of nozzles by the flushing operation is equal to or smaller than a volume of the pressure chamber communicating with the one nozzle in the plurality of pressure chambers.

16. The liquid ejecting apparatus according to claim 11, wherein
the first nozzle row and the second nozzle row are provided in the same nozzle plate.

17. The liquid ejecting apparatus according to claim 16, wherein
a shortest distance between nozzles of the first nozzle row and the second nozzle row is 1.5 mm or shorter.

18. A maintenance method for a liquid ejecting head having a first nozzle row that ejects a first liquid, the method comprising:
a pressurizing step of pressurizing an inside of a first tank storing the first liquid to be supplied to the first nozzle row in a closed state of a first supply flow path for supplying the first liquid to the first nozzle row from the first tank;
an opening step of discharging the first liquid from the first nozzle row by opening the first supply flow path after the pressurizing step; and
a closing step of closing the first supply flow path at a timing at which the first liquid is being continuously discharged from the first nozzle row by the opening step.

19. The maintenance method for a liquid ejecting head according to claim 18, wherein
the liquid ejecting head includes an ejecting surface including the first nozzle row and a second nozzle row that ejects a second liquid having a type different from a type of the first liquid,
in the pressurizing step, the inside of the second tank is pressurized in a closed state of the second supply flow path for supplying the second liquid to the second nozzle row from the second tank storing the second liquid to be supplied to the second nozzle row,
in the opening step, the second liquid is discharged from the second nozzle row by opening the second supply flow path,
in the closing step, the second supply flow path is closed at a timing at which the second liquid is being continuously discharged from the second nozzle row by the opening step, and
in the opening step, a period for maintaining an open state of the first supply flow path and a period for maintaining an open state of the second supply flow path at least partially overlap each other.

20. The maintenance method for a liquid ejecting head according to claim 19, further comprising:
a wiping step of causing a wiping member to wipe the ejecting surface in a closed state of both the first supply flow path and the second supply flow path, after the closing step.
